(19) United States
(12) Patent Application Publication
(10) Pub. No.: US 2003/0008959 A1
(43) Pub. Date: Jan. 9, 2003

(54) Vinyl chloride polymer/acrylic polymer capstocks

(76) Inventors: Charles C. Crabb, Royersford, PA (US); Peggy S. Schipper, Strafford, PA (US); Stephane J. Girois, Lyon (FR); Paul A. Ludwig, Harleysville, PA (US); Christopher A. Bertelo, Doylestown, PA (US)

Correspondence Address: ATOFINA Chemicals, Inc., Patent Department, 26th Floor, 2000 Market Street, Philadelphia, PA, 19103-3222, US

(21) Appl. No.: 10/160,818

(22) Filed: May 31, 2002

Related U.S. Application Data
(60) Provisional application No. 60/297,590, filed on Jun. 12, 2001.

(51) Int. Cl. C08K 5/04

(52) U.S. Cl. 524/399

(57) ABSTRACT

A composition, particularly suited for forming a surface layer (capstock) with excellent weathering properties of a composite which includes an underlaying layer of PVC or other structural plastic, is comprised of vinyl chloride polymer, an organotin maleate and an acrylic blend of an acylic monomer or copolymer resin and an acrylic weatherable impact modifier.

### FIELD OF INVENTION

The present invention relates to capstocks for vinyl chloride polymers in which the capstock is comprised of from about 50 to 90 parts vinyl chloride polymer, from 10 to about 50 parts acrylic and from 0.2 to 5 parts per hundred parts of resin (phr) of an organotin maleate.

### BACKGROUND OF THE INVENTION

Unplasticized polyvinyl chloride (PVC) polymer is one of the most economical polymers available. It is also one of the most difficult to thermally process by extrusion, injection molding and calendering. Consequently, fillers, lubricants, thermal stabilizers, pigments and processing aids are compounded with PVC resin to improve processability. The use of PVC is also limited by low resistance to heat, discoloring and embrittling if held at elevated temperature. Thermal stabilizers are added to minimize the effects of this characteristic. PVC articles also discolor and embrittle if exposed to sunlight for extended periods of time. The discoloration and embrittlement of PVC containing polymer articles are especially detrimental for articles intended for long-term weather exposure such as construction materials like house siding, window frames, rain systems, soffits, trim, pipe, panels, etc. While it is to be expected that there will be some change in the beneficial properties of PVC containing articles when exposed to weathering, the changes must be small, uniform and gradual over as much as 20 years. Accelerated weathering tests have been developed to simulate the long-term effect of weathering, i.e., changes in color, loss of impact strength.

There are hundreds of technical article reviews and patents related to compositions useful in the thermal stabilization and processing of PVC. One such review may be found in the Encyclopedia of PVC, edited by L. Nass and C. Heiberger, Second Edition, Volume 1, Chapter 8, “Theory of Degradation and Stabilization Mechanisms”.

Tetravalent organotin molecules are known to be useful as PVC stabilizers. One or two valence sites on the tin molecule are occupied by organic groups bonded directly to tin through carbon. Typical organic groups are alkyl groups of 1 to 8 carbon atoms. The remaining valence sites on the tin molecule are filled by anionic groups bonded to tin through oxygen or sulfur. The sulfur-containing organotin stabilizers are known to be superior thermal processing stabilizers for PVC, contributing to viscosity control, color protection and physical properties retention.

However, it is also known that the sulfur-containing organotins are relatively poor stabilizers against sunlight and may even increase degradation due to sunlight exposure. On the other hand, it is known that organotin carboxylate, especially organotin maleates and organotin maleate esters, enhance the light stability of PVC articles, but that they are very poor processing stabilizers, actually causing the hot PVC to adhere to the heated processing equipment.

Approaches tried to resolve the poor weatherability of PVC have included the use of lead stabilizers, calcium-zinc stabilizer systems, bariums-cadmium stabilizer systems and the use of high levels of titanium dioxide pigment, typically 8 to 10 weight percent.

Lead compounds are considered undesirable from a safety point of view. Calcium-zinc stabilizer systems have shown some promise. However, the PVC compositions incorporating these systems require more careful and generally slower processing. Barium-cadmium system are also toxic. The use of 8 to 10 weight percent of titanium dioxide, particularly with organotin mercaptides, is effective; however, titanium dioxide is very expensive. At 10 weight percent of the PVC article, it can equal 50% of the pound volume cost of the article due to its very high specific gravity.

A widely employed alternative to the above described compositions is to employ a weatherable capstock over a lower cost, lower TiO₂ content substrate. The capstock is generally about 10 to 25 percent of the thickness of the composite or laminate, frequently applied by co-extrusion and serves to protect the substrate layer from UV sunlight contact.

Another alternative to achieving weather resistant PVC containing polymeric articles is to substitute the PVC of the capstock, in whole or in part, with a non-PVC polymer. Acrylic polymers have been proposed because of their excellent color stability in outdoor exposure; they cost, however, approximately twice as much as the polymer they are replacing.

Film laminates used as capstock materials to improve weatherability of PVC substrates perform satisfactorily but are limited to specialty applications due to their high cost, e.g. polyvinylidene difluoride.

The following listed patents describe some of the technology of weatherable laminates which are based on rigid PVC substrate compositions: EP 1061100A; EP 0473379A; U.S. Pat. Nos. 4,141,935; 4,169,180; and 4,183,777.

### SUMMARY OF THE INVENTION

The present invention relates a resinous composition for use as a capcoat, the composition comprising from about 50 to 90 parts vinyl chloride polymer, from 10 to about 50 parts acrylic and from 0.2 to 5 parts per hundred parts of resin (phr) of an organo tin maleate, wherein the acrylic is comprised of an acylic monomer or copolymer resin and an acrylic weatherable impact modifier.

Another embodiment of the present invention is to multiple layer laminates or co-extrudates which are suitable for long-term outdoor exposure comprising:

a) a substrate layer comprising greater than 50 weight percent vinyl chloride polymer and

b) a capstock layer attached to and directly overlaying the substrate layer which protects the substrate from weathering effects due to heat, moisture and sunlight, the capstock layer being comprised of 10 to about 50 weight percent acrylic polymers and from about 50 to 90 weight percent of vinyl chloride polymer and additionally containing at least one organotin maleate.

### DETAILED DESCRIPTION OF THE INVENTION

The present invention relates to compositions useful to produce polymer laminates which are useful in weather exposed conditions and which are comprised of a substrate which may have relatively low-resistance to degradation when exposed directly to the elements, especially sunlight, and a topcoat layer, also known as a capstock, having adequate weather stability that, of itself, is weather stable and further protects the substrate to which it is applied, for example, by co-extrusion, against weather degradation.

An objective of the present invention is economical and useful superstrate layer compositions for vinyl chloride polymer substrates intended for use involving exposure to the elements, especially sunlight.

Another objective of the present invention is to provide a useful capstock composition for vinyl chloride polymer substrates which as a composite structure or laminate meets the physical properties and stability required for specified uses, e.g., non-delaminating freedom from curling, acceptable gloss, stable color and impact strength retention.

Another objective of the present invention is to provide a useful capstock composition which can be processed on extrusion, molding and calendering equipment without sticking or burning.

Another objective of the present invention is to provide useful capstock compositions which compositions utilize light stabilizing organotin maleate and maleate half ester as the primary thermal stabilizer.

Another objective of the present invention is to provide useful capstock composition comprising about 50 weight percent or less of acrylic polymer and about 50 weight percent or greater of vinyl chloride polymer.

Another objective of the present invention is to provide useful capstock compositions comprising about 50 weight percent to 90 weight percent vinyl chloride polymer and organo stannoxane maleates and/or maleate half ester stabilizers which exhibit little, if any, loss in stability as the vinyl chloride polymer content is increased from about 50 to 90 weight percent.

The present invention is novel polymeric compositions useful as weather resistant capstock, for use over light sensitive, for example, polyvinyl chloride (PVC) substrates. These laminates or co-extrudates may be used in construction material, particularly, house siding, window frames, gutters and downspouts, shutters, pipe, fencing, etc. The compositions of the invention are processable by extrusion, co-extrusion, calendering and injection molding without producing undesirable side effects frequently encountered with PVC composites containing organotin maleate as the stabilizer such as melt viscosity increase, sticking, burning of the polymer, eye irritation and loss of output.

The compositions of the invention comprises ingredients frequently present in weatherable vinyl chloride polymer composites, i.e., a vinyl chloride polymer, acrylic polymer, process aids, pigment, impact modifier, lubricants, thermal stabilizers and light stabilizers. The compositions of the invention, however, are based on specific ingredients and percentage relationships.

The substrate comprises 95 to 75% by weight of the composition structure.

The vinyl chloride polymer which may be used in the substrate of a composite structure of the invention or in the capstock composition can be any vinyl chloride polymer or copolymer composition, particularly one or more addition polymers chosen from the group formed by vinyl chloride homopolymers, which can optionally be overchlorinated, and the copolymers, optionally grafted, which result from the copolymerization of vinyl chloride with one or more ethylenically unsaturated comonomers.

The following are particularly suitable as comonomers for the preparation of such copolymers: vinylidene halides, such as vinylidene chloride or fluoride, vinyl carboxylates, such as vinyl acetate, vinyl propionate or vinyl butyrate, acrylic and methacrylic acids and the nitrites, amides and alkyl esters which derive therefrom, in particular acrylonitrile, acrylamide, methacrylamide, methyl methacrylate, methyl acrylate, butyl acrylate, ethyl acrylate or 2-ethylhexyl acrylate, vinylaromatic derivatives, such as styrene or vinylnaphthalene, or olefins, such as bicyclo[2.2.]hept-2-ene, bicylco[2.2.1]hepta-2,5-diene, ethylene, propene or 1-butene.

Among these polymers, the invention very particularly relates to homo- and copolymers of vinyl chloride (PVC), which are optionally overchlorinated. The most widely used PVC is a homopolymer with a K value of 65.

The acrylic of the capstock is preferably a mixture of an acrylic ester polymer and an impact modifier acrylic polymer, which may be in a ratio of 20 to 80 weight/weight percent acrylic ester polymer and 80 to 20 weight/weight percent impact modifier acrylic polymer.

As a class, acrylics, known for their excellent optical characteristics, surface gloss, resistance to degradation by sunlight, hardness, inertness to water and common chemicals, durability, and toughness, are capstocks of choice for various structural plastics.

The mechanical properties of the capstock generally are secondary to those of the structural plastic, but it is important that the capstock not adversely affect the mechanical properties of the composite.

The term “acrylic ester polymer(s)” as used herein means

1) alkyl methacrylate homo polymers,

2) copolymers of alkyl methacrylates with other alkyl methacrylates or alkyl acrylates, or methacrylic acid

3) alkyl acrylate homopolymers, and

4) copolymers of alkyl acrylates with other alkyl acrylates or alkyl methacrylates.

The alkyl group can be from 1-18 carbon atoms, preferably 1-4 carbon atoms.

Preferred are polymethyl methacrylate (PMMA) copolymers in which the PMMA is present at 60 to 99.9% and the comonomer is a short chain alkyl acrylate. Preferred comonomers are methyl and ethyl acrylate. More preferred is a PMMA copolymer, the PMMA content comprising 75 to 99.9 weight percent of the copolymer and comonomer comprising 0.1 to 25, preferably 1 to 10, weight percent and being a C₁-C₁₀ alkyl acrylate, preferably methyl or ethyl acrylates.

The molecular weight of the acrylic ester polymer may be varied depending on desired viscosity of the resulting polymer. It is generally preferred that the viscosity of the resulting polymer be similar to the underlying PVC substrate to improve fabrication. A molecular weight (weight average) above about 80,000 is desired to maintain physical properties, such as toughness and heat distortion temperature, while values of above about 200,000 are too high in melt viscosity to be readily fabricated.

A suitable commercially available polymethyl methacrylate type thermoplastic material is Plexiglas® V-grade molding powder, such as Plexiglas® V-825, V-826, V-045, V052, VM, VS, and V-920 etc., which are sold by ATOFINA Chemicals, Inc.

The impact modifier portion of the acrylic resin is an acrylic core shell impact modifier usually having two or three stages. The modifier is usually made by an emulsion process. In an emulsion process, particles which are generated are usually small, 0.05-5 micrometers. In an emulsion process, the major components are monomers, water, emulsifiers, water-soluble initiators and chain transfer agents. The water to monomer ratio is controlled between 70:30 and 40:60.

The impact modifier resin comprises multi-layered polymeric particles. Speaking generally such resins are prepared by emulsion polymerizing a mixture of monomers in the presence of a previously formed polymeric product. More specifically, such resins are prepared from monomers in aqueous dispersion or emulsion and in which successive monomeric charges are polymerized onto or in the presence of a preformed latex prepared by the polymerization of a prior monomer charge and stage. The polymeric product of each stage can comprise a homopolymer or a copolymer. In this type of polymerization, the polymer of the succeeding stage is attached to and intimately associated with the polymer of the preceding stage.

In such core/shell structures for the present use, required is at least one rubbery stage which is predominantly derived from units of a lower alkyl acrylate, preferably butyl acrylate. The amount of outer stage may vary, depending on how the impact modifier is to be isolated. To spray-dry, sufficient outer stage is required to allow the resultant product to flow freely. The composition of the outer stage is preferably very similar to that of the matrix polymer, that is, a polymer comprised of units derived from methyl methacrylate copolymerized with an alkyl acrylate.

Multi-stage structures may be utilized in the core/shell polymer, as long as the outer stage and at least one rubbery stage are present, so that two, three-, four- and multi-stage structures may be formed.

Preferred, as taught in Owens U.S. Pat. No. 3,793,402, is a multi-layered polymeric particle comprising three sequential stages of a non-rubbery non-shell stage, first stage polymer, an elastomeric second stage polymer and a relatively hard third stage polymer, with the monomers (co-monomers) used in preparing each stage of the resin being selected, as described in the Owens patent, to provide stages or layers that have the aforementioned non-elastomeric, elastomeric, and hard properties.

As taught in the Owens patents, it is preferred that at least one of the rubbery or non-shell non-rubbery stage contains units derived from at least one monomer having more than one copolymerizable double bond.

Preferred particles are those in which the core layer and the outer layer thereof comprise resins which are made from the same monomer(s) that are used to prepare the acrylic ester polymer matrix of the composition, that is, random copolymers of methyl methacrylate (about 70 to about 80 wt. %) and a C1 to C4 alkyl acrylate (about 30 to about 20 wt. %), most preferably ethyl acrylate, a graft-linking monomer, such as allyl methacrylate, diallyl maleate, and the like, and optionally, a polyfunctional cross-linking monomer, such as ethylene glycol dimethacrylate, butylene glycol diacrylate, and the like.

The composition of a preferred impact modifier may be 5-90% methyl methacrylate, 10-95% C₂-C₄ alkyl methacrylate, and optionally 0-5% acrylic monomers such as methacrylic acid, acrylic acid or C₁-C₅ esters thereof.

It is preferable that the acrylic ester polymer matrix and modifier emulsions be blended together followed by isolation by spray-drying of coagulation.

The maleate stabilizers used in the capstock composition are organotin maleates or organotin (maleate) (oxides) having at least one half ester maleate moiety in which the alcohol-derived portion consists of C₁ to C₅₀ alcohols.

Such organotin maleates are obtained by reacting a component RA with maleic anhydride or maleic acid, optionally in a solvent medium and/or in the presence of water, and by then bringing the reaction mixture thus obtained into contact with at least one dialkyltin oxide (R¹)₂Sn═O or with at least one alkyltin chloride (R¹)ₓ SnCl₄₋ₓ, given that:

RA represents either

(a) an alcohol ROH in which R represents a linear or branched aliphatic hydrocarbon radical having a number of carbon atoms ranging from 1 to 50 or a mixture of saturated primary alcohols with a weight-average molecular mass Mw ranging from 32 to 718, or

(b) an epoxyalkane Cₙ H₂ₙO in which n ranges from 1 to 50 or a mixture of epoxyalkanes with a weight-average molecular mass Mw ranging from 30 to 718;

R¹ represents a linear or branched aliphatic hydrocarbon radical having a number of carbon atoms ranging from 1 to 12 and preferably equal to 1, 4 or 8, and

x is an integer equal to 1 or 2.

Preferred are high molecular weight organotin maleates described in U.S. Pat. Nos. 5,985,967 and 6,156,832.

Also preferred are organotin maleates or organotin (maleate) (oxides) having at least one half ester maleate moiety in which the alcohol-derived portion consists of C₁₆ to C₂₂ alcohols. These organotin maleates are preferred because they process better and are less lachrymose.

U.S. Pat. No. 5,985,967 discloses organotin maleates obtained by reacting a component RA with maleic anhydride or maleic acid, optionally in a solvent medium and/or in the presence of water, and by then bringing the reaction mixture thus obtained into contact with at least one dialkyltin oxide (R¹)₂ Sn═O or with at least one alkyltin chloride

(R¹)ₓ SnCl₄₋ₓ, given that:

RA represents either

(a) an alcohol ROH in which R represents a linear or branched aliphatic hydrocarbon radical having a number of carbon atoms ranging from 23 to 50 or a mixture of saturated primary alcohols with a weight-average molecular mass Mw ranging from 340 to 718 and a polydispersity Mw/Mn in the region of 1 (Mn representing the number-average molecular mass), or

(b) an epoxyalkane Cₙ H₂ₙO in which n ranges from 23 to 50 or a mixture of epoxyalkanes with a weight-average molecular mass Mw ranging from 338 to 716;

R¹ represents a linear or branched aliphatic hydrocarbon radical having a number of carbon atoms ranging from 1 to 12 and preferably equal to 1, 4 or 8, and x is an integer equal to 1 or 2.

U.S. Pat. No. 6,156,832 discloses organotin maleates obtained by reacting, optionally in solvent medium and/or in the presence of water, a mixture composed of at least one component RA and at least one component R² A with maleic anhydride or maleic acid and by then bringing the reaction mixture thus obtained into contact with at least one dialkyltin oxide (R¹)₂ Sn═O or at least one alkyltin chloride (R¹)ₓ SnCl₄₋ₓ, given that:

RA represents either

(a) an alcohol ROH in which R represents a linear or branched aliphatic hydrocarbon radical having a number of carbon atoms ranging from 1 to 10 and preferably of between 5 and 8 or a mixture of alcohols with a weight-average molecular mass Mw greater than 32 and not more than 158, or

(b) an epoxyalkane Cₙ H₂ₙO in which n ranges from 1 to 10 or a mixture of epoxyalkanes with a weight-average molecular mass Mw greater than 30 and not more than 156;

R² A represents (a) an alcohol R²OH in which R² represents a linear or branched aliphatic hydrocarbon radical having a number of carbon atoms ranging from 20 to 50 or a mixture of alcohols with a weight-average molecular mass Mw ranging from 298 to 718, or

(b) an epoxyalkane Cₙ H₂ₙO in which n ranges from 20 to 50 or a mixture of epoxyalkanes with a weight-average molecular mass Mw ranging from 296 to 716;

R¹ represents a linear or branched aliphatic hydrocarbon radical having a number of carbon atoms ranging from 1 to 12 and preferably equal to 1, 4 or 8, and x is an integer equal to 1 or 2.

The level of organotin maleate stabilizers will be 0.2 to 5 parts per hundred resin (phr) in the capstock, preferred is 2-4 phr, most preferred is about 3 phr. Co-stabilizers such as zeolite, organotin mercaptides and calcium zinc stabilizers may be used with the organotin maleate stabilizer.

The capcoat composition can be made by many different processes known in the art, including continuous cell casting, emulsion, suspension, bulk polymerization, and continuous stirred tank reactions (CSTR), etc. Each of these methods uses free radical polymerization chemistry. It should also be noted that the art also contains Ionic polymerization methods to prepare acrylic.

The capstock composition may also include other modifiers or additives that are well known in the art. For example, the composition may contain other impact modifiers, external lubricants, antioxidants, flame-retardants or the like. If desired, ultraviolet stabilizers, flow aids, metal additives for electronic magnetic radiation shielding such as nickel coated graphite fibers, anti-static agents, coupling agents, such as amino silanes, and the like, may also be added.

The capstock or protector layer improves the physical properties of the composites, i.e., impact strength retention, heat distortion resistance, light resistance.

### EXAMPLE 1

In general the capstock compositions are made as follows: PVC resin is charged to a mixer, such as a Henschel Mixer, followed by the addition of the stabilizer. Mixing begins. When the temperature reaches 62° C., the acrylic resin [being the acylic ester polymer matrix and acylic impact modifier(s)] along with any lubricants, such as AC-629A, calcium stearate, XL165, Acrawax C and Rheolub 165 are added. When the temperature reaches 82° C. the other additives and processing aids, such as Durastrength-200 and Tinuvin 123, are added. Lastly, when the temperature reaches 88° C., the pigment, such as TiO2, is added and the blend mixed for 90 more seconds. The blend is then removed from the mixer and allowed to cool.

Using the above procedure, the following white formations were made, some of which were tested in the following Examples.

| | | | | | 11 | | 15 | 20 |
|---|---|---|---|---|---|---|---|---|
| | 01B | 03B | 05B | 09 | Present | 13 | Present | Present |
| | Control | Control | Control | Control | Invention | Control | Invention | Invention |
| Base Resin | | | | | | | | |
| PVC (Geon | 100 | 100 | 100 | 50 | 50 | 75 | 75 | 75 |
| 103) | | | | | | | | |
| Acrylic | | | | 50 | 50 | 25 | 25 | 25 |
| Resin | | | | | | | | |
| Total | 100 | 100 | 100 | 100 | 100 | 100 | 100 | 100 |
| Stabilizer | | | | | | | | |
| Thermolite | 1.5 | | | 1.5 | | 1.5 | | |
| 31 | | | | | | | | |
| Thermolite | | 3 | | | 3 | | 3 | |
| 410 | | | | | | | | |
| Thermolite | | | 1.5 | | | | | |
| 340 | | | | | | | | |
| Thermolite | | | | | | | | 3 |
| 400 | | | | | | | | |
| Other | | | | | | | | |
| Additives | | | | | | | | |
| Durastrength | 6 | 6 | 6 | 6 | 6 | 6 | 6 | 6 |
| 200 | | | | | | | | |
| AC-629A | 0.15 | | 0.15 | 0.2 | 0.2 | 0.2 | 0.2 | 0.2 |
| (OPE) | | | | | | | | |
| Calcium | 1.2 | | 1.2 | 0.5 | 0.5 | 0.5 | 0.5 | 0.5 |
| Stearate | | | | | | | | |
| XL165 | 1 | | 1 | 1 | 1 | 1 | 1 | 1 |
| L1000 | | | | 1 | 1 | 1 | 1 | 1 |
| Acrawax-C | | | | 0.5 | 0.5 | 0.5 | 0.5 | 0.5 |
| Rheolub 165 | | 1.5 | | | | | | |
| (010) | | | | | | | | |
| Metablen P- | 0.6 | 0.6 | 0.6 | | | | | |
| 501 | | | | | | | | |
| Metablen P- | 0.4 | 0.4 | 0.4 | | | | | |
| 710 | | | | | | | | |
| Tinuvin-123 | | | | 0.5 | 0.5 | 0.5 | 0.5 | 0.5 |
| TiO2 - RCL4 | 10 | 10 | 10 | 10 | 10 | 10 | 10 | 10 |

Using the above procedure, the following gray formations were made, some of which were tested in the following Examples.

| | | | | | 12 | | 16 | | 18 |
|---|---|---|---|---|---|---|---|---|---|
| | | | | 10 | Present | 14 | Present | 17 | Present |
| | 02B | 04B | 06B | Control | Invention | Control | Invention | Control | Invention |
| | Control | Control | Control | 50/50 | 50/50 | 75/25 | 75/25 | 50/50 | 50/50 |
| Comments | 100 | 100 | 100 | T31 | T410 | T31 | T410 | T31 | T410 |
| Base Resin | | | | | | | | | |
| PVC (Geon | 100 | 100 | 100 | 50 | 50 | 75 | 75 | 50 | 50 |
| 103) | | | | | | | | | |
| Acrylic | | | | 50 | 50 | 25 | 25 | 50 | 50 |
| Resin | | | | | | | | | |
| Total | 100 | 100 | 100 | 100 | 100 | 100 | 100 | 100 | 100 |
| Stabilizer | | | | | | | | | |
| Thermolite | 1.5 | | | 1.5 | | 1.5 | | 1.5 | |
| 31 | | | | | | | | | |
| Thermolite | | 3 | | | 3 | | 3 | | 3 |
| 410 | | | | | | | | | |
| Thermolite | | | 1.5 | | | | | | |
| 340 | | | | | | | | | |
| Other | | | | | | | | | |
| Additives | | | | | | | | | |
| Durastrength | 6 | 6 | 6 | 6 | 6 | 6 | 6 | 6 | 6 |
| 200 | | | | | | | | | |
| AC-629A | 0.15 | | 0.15 | 0.2 | 0.2 | 0.2 | 0.2 | 0.2 | 0.2 |
| (OPE) | | | | | | | | | |
| Calcium | 1.2 | | 1.2 | 0.5 | 0.5 | 0.5 | 0.5 | 0.5 | 0.5 |
| Stearate | | | | | | | | | |
| XL165 | 1 | | 1 | 1 | 1 | 1 | 1 | 1 | 1 |
| L100 | | | | 1 | 1 | 1 | 1 | 1 | 1 |
| Acrawax-C | | | | 0.5 | 0.5 | 0.5 | 0.5 | 0.5 | 0.5 |
| Rheolub | | 1.5 | | | | | | | |
| 165 (010) | | | | | | | | | |
| Metablen | 0.6 | 0.6 | 0.6 | | | | | | |
| P-501 | | | | | | | | | |
| Metablen | 0.4 | 0.4 | 0.4 | | | | | | |
| P-710 | | | | | | | | | |
| Tinuvin- | | | | 0.5 | 0.5 | 0.5 | 0.5 | | |
| 123 | | | | | | | | | |
| TiO2 - | 10 | 10 | 10 | 10 | 10 | 10 | 10 | 10 | |
| CR822 | | | | | | | | | |
| Blue | 4.53 | 4.53 | 4.53 | 4.53 | 4.53 | 4.53 | 4.53 | 4.53 | 4.53 |
| Pigment | | | | | | | | | |

The Acrylic Resin used in the examples is an impact modified acrylic having a composition similar to Plexiglas DR which is available from ATOFINA Chemicals, Inc. It is composed of an acrylic copolymer as described in paragraph 32-34 and the impact modifier of paragraph 39.

Durastrengh® 200 is a weatherable acrylic impact modifier for PVC available from ATOFINA.

Rheolube 165 is a paraffin wax lubricant having a melt point of 165 degrees.

Metablen® P501 is a PMMA-based polymeric process aid for PVC available from ATOFINA.

Metablen® P701 is a PMMA-based polymeric processing aid for PVC containing an additional lubrication functionality, available from ATOFINA.

Blue Pigment is available from Holland Color as dark blue-grey, #932256.

Metablen® L1000 is a polymeric acrylic lubricant for polymers available from ATOFINA.

Acrowax C is a bis-stearamide wax.

AC 629A is an oxidized polyethylene wax available from Allied Chemical.

Thermolite® 31 is dibutyltin-bis-2-ethylhexyl-mercaptoacetate available from ATOFINA.

Thermolite® 340 is butyltin-2-ethylhexyl-mercaptoacetate sulfide available from ATOFINA.

Thermolite® 400 is a dibutyltin maleate ester formed from the reaction of dibutyltin oxide, maleate anhydride and stearyl alcohol, modified by the addition of 20 weight percent of inorganic extender, which is characterized by a typical tin content of 16 weight percent, an acid number of 130 and a saponification number of 185 and is available from ATOFINA.

Thermolite® 410 is a dibutyltin maleate ester formed from the reaction of dibutyltin oxide, maleate anhydride, and 2-ethylhexanol and a C30 alcohol blend, modified by the addition of 20 weight percent of inorganic extender, which is characterized by a typical tin content of 16 weight percent, an acid number of 130 and a saponification number of 185 and is available from ATOFINA.

Tinuvin 123 is a hindered amine light stabilizer available from Ciba Specialty Chemicals, Inc.

### EXAMPLE 2

Evaluations of color stability of white samples made in Example 1 were performed in the following manner:

Dry blend mixtures of each formulation were prepared according to standard industry procedures. A portion of each dry blend was then extruded on a twin screw extruder to form a sheet. Portions of each sheet were cut to form smooth plaques useful in weather exposure tests.

Accelerated testing was carried out using a QUV apparatus.

Color change evaluations were carried out by machine, measuring the Delta E, that is change in units from standard versus exposure time.

WHITE Formulations

| | | | | | 11 | | 15 |
|---|---|---|---|---|---|---|---|
| | | | | 09 | Present | 13 | Invention |
| | | | | PVC/ | Invention | PVC/ | PVC/ |
| | 01B | 03B | 05B | Acrylic | PVC/Acrylic | Acrylic | Acrylic |
| Time | T31 | T410 | T-340 | 50/50 | 50/50 | 75/25 | 75/25 |
| Weeks | Control | Control | Control | T31 | T410 | T31 | T410 |
| 0 | 0.00 | 0.00 | 0.00 | 0.00 | 0.00 | 0.00 | 0.00 |
| 1 | 0.37 | 0.43 | 0.64 | 0.17 | 0.17 | 0.35 | 0.56 |
| 2 | 0.56 | 0.60 | 0.86 | 0.20 | 0.35 | 0.43 | 0.73 |
| 3 | 0.92 | 0.28 | 1.19 | 0.30 | 0.32 | 0.52 | 0.72 |
| 4 | 1.26 | 0.38 | 1.69 | 0.41 | 0.43 | 0.50 | 0.64 |
| 5 | 1.52 | 0.03 | 2.17 | 0.46 | 0.37 | 0.81 | 0.72 |
| 6 | 2.08 | 0.45 | 2.34 | 0.76 | 0.41 | 1.08 | 0.78 |
| 7 | 2.54 | 0.73 | 2.64 | 0.95 | 0.72 | 1.21 | 0.99 |
| 8 | 2.62 | 0.30 | 3.08 | 0.85 | 0.45 | 0.92 | 0.74 |
| 9 | 2.87 | 0.66 | 3.65 | 1.04 | 0.52 | 1.26 | 0.87 |
| 10 | 3.52 | 0.79 | 3.89 | 1.14 | 0.60 | 1.44 | 0.89 |
| 11 | 3.82 | 1.02 | 3.89 | 1.20 | 0.57 | 1.49 | 0.89 |
| 12 | 3.68 | 1.12 | 4.40 | 1.42 | 0.73 | 1.70 | 1.09 |
| 13 | 3.40 | 1.34 | 3.95 | 1.30 | 0.58 | 1.73 | 0.82 |
| 14 | 4.41 | 1.34 | 4.05 | 1.27 | 0.65 | 1.70 | 0.89 |
| 15 | 4.30 | 1.96 | 4.31 | 1.57 | 0.77 | 2.03 | 0.95 |
| 16 | 4.14 | 1.96 | 4.18 | 1.73 | 0.78 | 2.09 | 1.00 |
| 17 | 3.98 | 2.03 | 3.93 | 1.67 | 0.85 | 2.20 | 1.06 |
| 18 | 5.02 | 2.53 | 4.59 | 2.08 | 0.92 | 2.50 | 1.17 |
| 19 | 5.21 | 3.46 | 5.16 | 2.33 | 0.94 | 3.03 | 1.18 |
| 20 | 5.44 | 3.11 | 5.04 | 2.38 | 1.07 | 3.28 | 1.35 |
| 21 | 5.39 | 3.22 | 5.02 | 2.34 | 0.98 | 3.21 | 1.29 |
| 22 | 5.34 | 3.31 | 5.12 | 2.65 | 1.18 | 3.54 | 1.45 |
| 23 | 5.13 | 3.28 | 4.97 | 2.66 | 1.16 | 3.72 | 1.32 |
| 24 | 5.22 | 3.04 | 4.83 | 2.76 | 1.24 | 3.82 | 1.48 |
| 25 | 5.01 | 3.28 | 4.92 | 3.00 | 1.38 | 4.11 | 1.57 |
| 26 | 4.96 | 3.22 | 4.95 | 2.93 | 1.56 | 4.34 | 1.74 |
| 27 | 5.00 | 3.21 | 4.90 | 2.97 | 1.37 | 4.17 | 1.51 |
| 28 | 5.10 | 2.96 | 5.02 | 3.12 | 1.39 | 4.48 | 1.73 |
| 29 | 5.03 | 2.71 | 4.91 | 3.28 | 1.43 | 4.29 | 2.01 |
| 30 | 4.98 | 2.22 | 4.72 | 3.06 | 1.35 | 4.37 | 1.74 |
| 31 | 5.06 | 2.58 | 5.23 | 3.35 | 1.39 | 4.32 | 1.92 |
| 32 | 5.10 | 2.78 | 5.44 | 3.49 | 1.51 | 4.67 | 2.10 |
| 33 | 5.20 | 2.54 | 5.24 | 3.42 | 1.49 | 4.49 | 1.91 |
| 34 | 5.11 | 2.38 | 4.92 | 3.40 | 1.48 | 4.46 | 1.76 |
| 35 | 5.05 | 2.59 | 5.07 | 3.51 | 1.57 | 4.49 | 2.05 |
| 36 | 4.90 | 2.37 | 4.88 | 3.73 | 1.59 | 4.57 | 2.13 |
| 37 | 5.12 | 2.25 | 4.91 | 3.73 | 1.67 | 4.47 | 2.22 |
| 38 | 4.88 | 1.79 | 4.76 | 3.43 | 1.50 | 4.04 | 2.07 |
| 39 | 4.63 | 1.66 | 4.72 | 3.41 | 1.47 | 4.05 | 2.31 |
| 40 | 4.61 | 1.68 | 4.79 | 3.27 | 1.40 | 4.02 | 2.13 |
| 41 | 4.82 | 1.89 | 4.81 | 3.28 | 1.43 | 3.95 | 1.79 |
| 42 | 4.55 | 1.47 | 4.43 | 2.95 | 1.35 | 4.04 | 1.79 |
| 43 | 5.01 | 1.93 | 5.03 | 3.11 | 1.31 | 4.30 | 1.94 |
| 44 | 4.42 | 1.26 | 4.16 | 2.89 | 1.25 | 3.73 | 1.80 |
| 45 | 3.97 | 1.34 | 3.71 | 2.49 | 1.24 | 3.26 | 1.67 |
| 46 | 4.48 | 1.90 | 4.06 | 2.67 | 1.24 | 3.48 | 1.75 |
| 47 | 4.31 | 1.98 | 4.35 | 2.82 | 1.25 | 4.52 | 1.86 |
| 48 | 4.32 | 1.61 | 4.34 | 2.70 | 1.16 | 3.70 | 1.74 |
| 49 | 4.43 | 1.66 | 4.48 | 2.69 | 1.20 | 3.89 | 1.89 |
| 50 | 4.50 | 2.09 | 5.23 | 3.08 | 1.12 | 4.02 | 2.02 |
| 51 | 5.13 | 2.54 | 5.59 | 3.42 | 1.50 | 4.21 | 2.08 |
| 52 | 5.06 | 2.68 | 5.11 | 3.64 | 1.35 | 4.10 | 1.94 |

Conclusions:

Controls 01B and 05B are typical all-PVC capstock formulations using tin mercaptide stabilizers. They weather the worst.

Control 13 shows that improved weathering is obtained if acrylic is substituted for 25% of the PVC.

Control 09 shows additional improvement is obtained if the acrylic level is increased to 50%.

Control 03B shows that using a maleate stabilizer (T410) gives better weathering performance than do the mercaptide stabilizers (samples 01B and 05B).

However, the best weathering is obtained by combining the use of a maleate stabilizer with the substitution of an acrylic for 25% or 50% of the PVC (Present Invention Examples 11 and 15)

By using the maleate stabilizer, the sample containing only 25% acrylic, Present Invention Examples, weathers better than almost all of the other samples.

Only sample Present Invention Examples 11, which contains 50% acrylic and the maleate stabilizer, weathers better. And the difference in performance is small.

### EXAMPLE 3

Evaluations of color stability of white samples made in Example 1 were performed.

Actual outdoor exposures were conducted in Pennsylvania to represent an industrial atmosphere, Florida—a hot, moist atmosphere and Arizona—a hot, dry atmosphere. Plaques in the outdoor tests were mounted at 45 degrees, facing South. The number provided is the Delta-E value.

| | | | | | | | |
|---|---|---|---|---|---|---|---|
| Months of | | | | | 11 | | 15 |
| Exposure | 01B | 03B | 05B | 09 | Present Invention | 13 | Present Invention |

Pennsylvania weathering- white siding formulation

| | | | | | | | |
|---|---|---|---|---|---|---|---|
| 0 | 0 | 0 | 0 | 0 | 0 | 0 | 0 |
| 3 | 0.155 | 0.255 | 1.37 | 0.51 | 1.36 | 0.265 | 1.75 |
| 6 | 1.465 | 1.78 | 1.52 | 1.885 | 1.42 | 1.405 | 1.61 |
| 9 | 2.075 | 1.52 | 0.775 | 0.725 | 1.245 | 1 | 1.46 |
| 12 | 2.53 | 1.88 | 0.765 | 1.17 | 1.395 | 1.225 | 1.58 |
| 15 | 2.07 | 1.53 | 1.25 | 2.185 | 1.66 | 1.8 | 1.665 |
| 18 | 1.875 | 2.27 | 2.455 | 1.995 | 1.825 | 3.34 | 2.05 |

Arizona weathering- white siding formulation.

| | | | | | | | |
|---|---|---|---|---|---|---|---|
| 0 | 0 | 0 | 0 | 0 | 0 | 0 | 0 |
| 6 | 5.1 | 5 | 0.96 | 0.64 | 1.74 | 0.92 | 2.02 |
| 12 | 10.78 | 10.59 | 6.95 | 0.86 | 1.74 | 4.1 | 1.95 |
| 18 | 8.81 | 8.87 | 7.29 | 0.8 | 1.72 | 4.1 | 1.75 |

Florida Weathering- white siding formulation

| | | | | | | | |
|---|---|---|---|---|---|---|---|
| 0 | 0 | 0 | 0 | 0 | 0 | 0 | 0 |
| 6 | 2.77 | 3.1 | 0.52 | 0.93 | 0.92 | 1.11 | 1.17 |
| 12 | 1.65 | 1.89 | 0.3 | 0.68 | 1.13 | 1.03 | 1.32 |
| 18 | 3.47 | 2.87 | 0.8 | 1.8 | 0.65 | 2.14 | 0.86 |
| 18 | 5.09 | 3.78 | 0.46 | 1.43 | 0.4 | 3.84 | 1.15 |

Conclusions

Results vary somewhat by location because of the different environments.

In PA, all samples are discoloring about the same amount.

In FL, the samples containing acrylic and/or maleate stabilizer (SB, 9B, 11B) are performing the best.

In AZ, the maleate PVC Cap (5B) is doing a little better than the mercaptide based samples (1B and 3B), but the two acrylic samples (9B and 11B) are doing much better.

In PA and AZ, it can be seen that reducing the level of acrylic to 25% is detrimental when using a mercaptide stabilizer (9 vs. 13), but not when using a maleate stabilizer (11 vs. 15)

In FL, reducing the acrylic level has little effect, although the maleate stabilized samples are doing better than the mercaptide samples.

### EXAMPLE 4

Evaluations of color stability of Gray samples made in Example 1 were performed.

Actual outdoor exposures were conducted in Pennsylvania to represent an industrial atmosphere, Florida—a hot, moist atmosphere and Arizona—a hot, dry atmosphere. Plaques in the outdoor tests were mounted at 45 degrees, facing South. The number provided is the Delta-E value.

| | | | | | | | | | |
|---|---|---|---|---|---|---|---|---|---|
| | | | | | 12 | | 16 | | 18 |
| Months of | | | | | Present | | Present | | Present |
| Exposure | 02B | 04B | 06B | 10 | Invention | 14 | Invention | 17 | Invention |

Pennsylvania - gray siding formulation

| | | | | | | | | | |
|---|---|---|---|---|---|---|---|---|---|
| 0 | 0 | 0 | 0 | 0 | 0 | 0 | 0 | 0 | 0 |
| 3 | 0.805 | 0.86 | 0.17 | 0.155 | 0.215 | 0.215 | 0.13 | 0.165 | 0.165 |
| 6 | 1.895 | 1.685 | 0.195 | 0.41 | 0.39 | 0.79 | 0.375 | 0.275 | 0.345 |
| 9 | 3.81 | 3.415 | 0.755 | 0.255 | 0.275 | 1.905 | 0.27 | 0.44 | 0.175 |
| 12 | 5.83 | 5.935 | 1.63 | 0.305 | 0.185 | 3.695 | 0.225 | 1.22 | 0.515 |
| 15 | 7.27 | 8.07 | 3.605 | 1.425 | 0.735 | 6.06 | 1.09 | 2.515 | 2.135 |
| 18 | 7.885 | 7.03 | 2.16 | 0.845 | 0.425 | 5.03 | 0.325 | 1.77 | 0.835 |

Arizona weathering- gray siding formulation

| | | | | | | | | | |
|---|---|---|---|---|---|---|---|---|---|
| 0 | 0 | 0 | 0 | 0 | 0 | 0 | 0 | 0.00 | 0.00 |
| 6 | 0.8 | 0.89 | 0.93 | 0.47 | 0.47 | 0.3 | 0.39 | 0.24 | 0.24 |
| 12 | 3.44 | 2.43 | 1.73 | 0.69 | 0.33 | 4.54 | 0.77 | 1.12 | 1.84 |
| 18 | 2.48 | 1.75 | 1.33 | 1.82 | 0.3 | 4.89 | 1.29 | 2.38 | 2.56 |

Florida Weathering- gray siding formulation

| | | | | | | | | | |
|---|---|---|---|---|---|---|---|---|---|
| 0 | 0 | 0 | 0 | 0 | 0 | 0 | 0 | 0.00 | 0.00 |
| 6 | 1.21 | 1.04 | 0.26 | 0.23 | 0.23 | 0.86 | 0.2 | 0.35 | 0.11 |
| 12 | 4.73 | 3.75 | 0.55 | 1.17 | 0.37 | 3.32 | 0.85 | 1.44 | 0.86 |
| 18 | 5.09 | 3.78 | 0.46 | 1.43 | 0.4 | 3.84 | 1.15 | 1.43 | 0.97 |

Conclusions

Results vary somewhat by location because of the different environments.

In PA and FL, the standard PVC Capstock formulations containing mercaptide stabilizers discolor the most (02B and 04B).

In PA and FL, the samples containing 50% acrylic weather better than the standard capstock formulations.

In AZ, most of the samples are showing similar discoloration after 18 months—The acrylic/maleate stabilizer samples is doing the best (Sample 12).

In all three regions, the use of acrylic in conjunction with a maleate stabilizer gives outstanding weatherability, even when the acrylic level is reduced to 25% (Sample 16).

HALS (Samples 17 and 18) has a small beneficial effect on reducing discoloration due to weathering.

### EXAMPLE 5

Evaluations of impact strength retention of White samples made in Example 1 were performed.

Actual outdoor exposures were conducted in Pennsylvania to represent an industrial atmosphere, Florida—a hot, moist atmosphere and Arizona—a hot, dry atmosphere. Plaques in the outdoor tests were mounted at 45 degrees, facing South.

Impact retention versus exposure time was also machine measured and reported using Gardner Impact (ft-lbs/mil) outdoor weathering. All samples are about 40 mil total thickness.

Pennsylvania weathering- white siding formulation

| Months of Exposure | 01B | 03B | 05B | 09 | 11 | 13 | 15 |
|---|---|---|---|---|---|---|---|
| 0 | 2.82 | 2.79 | 2.88 | 2.19 | 2.08 | 2.85 | 2.18 |
| 6 | 2.74 | 2.66 | 2.92 | 1.83 | 1.81 | 2.28 | 2 |
| 12 | 2.45 | 2.36 | 2.95 | 1.83 | 1.52 | 2.44 | 1.73 |
| 18 | 2.48 | 2.31 | 2.2 | 1.04 | 1.66 | 2.39 | 1.23 |

| | | | | | | | |
|---|---|---|---|---|---|---|---|
| Months of | C9912- | C9912- | C9912- | | | C9912- | C9912- |
| Exposure | 01B | 03B | 05B | C9912-09 | C9912-11 | 13 | 15 |

Arizona weathering- white siding formulation

| | | | | | | | |
|---|---|---|---|---|---|---|---|
| 0 | 0 | 0 | 0 | 0 | 0 | 0 | 0 |
| 6 | 5.1 | 5 | 0.96 | 0.64 | 1.74 | 0.92 | 2.02 |
| 12 | 10.78 | 10.59 | 6.95 | 0.86 | 1.74 | 4.1 | 1.95 |
| 18 | 8.81 | 8.87 | 7.29 | 0.8 | 1.72 | 4.1 | 1.75 |

Florida Weathering- white siding formulation

| | | | | | | | |
|---|---|---|---|---|---|---|---|
| 0 | 2.82 | 2.79 | 2.88 | 2.19 | 2.08 | 2.85 | 2.18 |
| 6 | 3 | 3.07 | 3.3 | 1.9 | 1.88 | 3.12 | 2.87 |
| 12 | 2.8 | 2.74 | 2.9 | 1.23 | 1.74 | 2.6 | 1.82 |
| 18 | 2.59 | 2.56 | 2.71 | 0.3 | 1.63 | 0.97 | 1.92 |

Conclusions

Results vary somewhat by location because of the different environments.

Initial impact (Time=0) of all acrylic-containing samples (9 and 11) is less than the pure-PVC samples (1B, 3B, and 5B).

The use of a maleate stabilizer with acrylic (11 and 15) minimizes impact loss upon weathering, especially in AZ.

1- A composition for use as a capcoat, the composition comprising from about 50 to 90 parts vinyl chloride polymer, from 10 to about 50 parts acrylic and from 0.2 to 5 parts per hundred parts of resin (phr) of an organotin maleate, wherein the acrylic is comprised of an acylic monomer or copolymer resin and an acrylic weatherable impact modifier.

2- A multiple layer composition suitable for long-term outdoor exposure comprising:
(a)a substrate layer comprising greater than 50 weight percent vinyl chloride polymer and
(b) capstock layer attached to and directly overlaying the substrate layer which protects the substrate from weathering effects due to heat, moisture and sunlight, the capstock layer being comprised of 10 to about 50 weight percent acrylic polymers and from about 50 to 90 weight percent of vinyl chloride polymer and additionally containing at least one organotin maleate.
